(19) United States
(12) Patent Application Publication
(10) Pub. No.: US 2003/0212865 A1
(43) Pub. Date: Nov. 13, 2003

(54) Method and apparatus for flushing write cache data

(76) Inventors: Michael S. Hicken, Rochester, MN (US); James N. Snead, Eyota, MN (US)

Correspondence Address: Edward P. Heller, Moser, Patterson & Sheridan, LLP, Suite 250, 350 Cambridge Avenue, Palo Alto, CA, 94306, US

(21) Appl. No.: 10/435,721

(22) Filed: May 8, 2003

Related U.S. Application Data
(60) Provisional application No. 60/379,036, filed on May 8, 2002.

(51) Int. Cl. G06F 12/12

(52) U.S. Cl. 711/135

(57) ABSTRACT

A method and apparatus for flushing a write cache includes receiving a read or a write storage request, determining whether the storage request comprises a full or partial hit with data stored in a write cache one or more lines, some of which may be dirty. If the hit is partial and the one or more lines of the data are dirty, flushing the dirty data. If the hit is full or partial and any of the write cache lines are not dirty, and the storage request is a write request, flushing the dirty write cache lines, invalidating the non dirty write cache line, writing the storage request data into the write cache as a new write cache line and marking the new write cache line dirty. If the hit is full, all write cache lines are marked dirty, and the storage request is a write request, overlaying the cache write line with the storage request data and marking the write cache line as dirty.

### CROSS-REFERENCE TO RELATED APPLICATIONS

This application claims benefit of U.S. Provisional Patent Application No. 60/379,036 filed May 8, 2002, which is herein incorporated by reference in its entirety.

### BACKGROUND OF THE INVENTION

1. Field of the Invention

The present invention generally relates to data storage systems, and more particularly, to the management of a cache memory of data storage systems.

2. Description of the Related Art

Data storage systems are used within computer networks and systems to store large amounts of data that is used by multiple servers and client computers. Generally, one or more servers are connected to the storage system to supply data to and from a computer network. The data is transferred through the network to various users or clients. The data storage system generally comprises a controller that interacts with one or more storage devices such as one or more Winchester disk drives or other forms of data storage. To facilitate uninterrupted operation of the server as it reads and writes data from/to the storage system as well as executes applications for use by users, the storage system comprises a write cache that allows data from the server to be temporarily stored in the write cache prior to being written to a storage device. As such, the server can send data to the storage system and the data storage system can quickly acknowledge that the storage system has stored the data. The acknowledgement is sent even though the storage system has only stored the data in the write cache and is waiting for an appropriate, convenient time to store the data in a storage device. As is well known in the art, storing data to a write cache is much faster than storing data directly to a disk drive.

The write cache is managed, in various ways, such that it stores the instruction or data most likely to be needed at a given time. When the storage system accesses the write cache and it contains the requested data, a cache “hit” occurs. Otherwise, if the write cache does not contain the requested data, a cache “miss” occurs. Thus, the write cache contents are typically managed in an attempt to maximize the cache hit-to-miss ratio.

A cache, in its entirety, may be flushed periodically, or when certain predefined conditions are met. Further, individual cache lines may be flushed as part of a replacement algorithm. In each case, dirty data (i.e., data not yet written to persistent memory) in the cache, or in the cache line, is written to persistent memory. Bits, which identify the blocks of a flushed cache line are subsequently cleared. The flushed cache or flushed cache lines can then store new blocks of data.

Known systems use a replacement algorithm to flush cache line(s) when a cache line is needed. Such systems may further perform a full cache flush just before system shutdown. Such systems are inefficient and expose write-back data to loss. Specifically, if write-back data kept in the cache (i.e., dirty data) is not flushed until the system shutdown or until a replacement algorithm determines it is the cache line to be replaced, it is kept in the cache for a prolonged time period, during which it is subject to loss, before it is written to persistent memory.

Other known systems flush the cache when a central processing unit (CPU) idle condition is detected, in addition to flushing subject to a replacement algorithm and/or system shutdown. While dirty data in these systems is less likely to be lost, using CPU idle as the only factor for determining when to flush a cache also has shortcomings. For example, it is possible for the data bus to be overloaded when the CPU is idle. This is evident in systems employing one or more direct memory access (or “DMA”) units, because DMA units exchange data with memory exclusive of the CPU. Flushing the cache during DMA interaction would further burden an already crowded data bus.

Therefore it is apparent that a need exists in the art for an improved flushing method, which further reduces the overhead processing time of a data storage system while maximizing the “hit” ratio.

### SUMMARY OF THE INVENTION

The disadvantages of the prior art are overcome by a method and apparatus for flushing write cache data.

The method comprises receiving a read or a write storage request and determining whether the storage request comprises a full or partial hit with data stored in a write cache in the form of one or more write cache lines, some of which may be dirty. If the hit is partial and the one or more lines of the data are dirty, flushing the dirty data. If the hit is full or partial and any of the write cache lines are not dirty, and the storage request is a write request, flushing the dirty write cache lines, invalidating the non dirty write cache line, writing the storage request data into the write cache as a new write cache line and marking the new write cache line dirty. If the hit is full, all write cache lines are marked dirty, and the storage request is a write request, overlaying the cache write line with the storage request data and marking the write cache line as dirty.

The method further comprises receiving a storage request, determining whether the storage request comprises a partial hit with dirty data stored in a cache, and flushing, if the storage request is determined to be a partial hit, the dirty data of the write cache comprising the partial hit. As such, the dirty data is written to a persistent memory such as a disk drive array.

In another embodiment of the present invention, in a system having a host computer and a mass storage device, a disk array controller includes an input/output interface for permitting communication between the host computer, the mass storage controller, and the mass storage device, a write cache having a number of cache lines, some of which cache lines may include dirty data, and an input/output management controller. The input output management controller includes a means for receiving a storage request, a means for determining whether the storage request comprises a partial hit with dirty data stored in a cache, and a means for flushing, if the storage request is determined to be a partial hit, the dirty data of the write cache comprising the partial hit.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a high level block diagram of a data storage system 100 including an embodiment of the present invention; and

FIG. 2 depicts a flow diagram of an embodiment of a method of the present invention for forced flushing.

### DETAILED DESCRIPTION

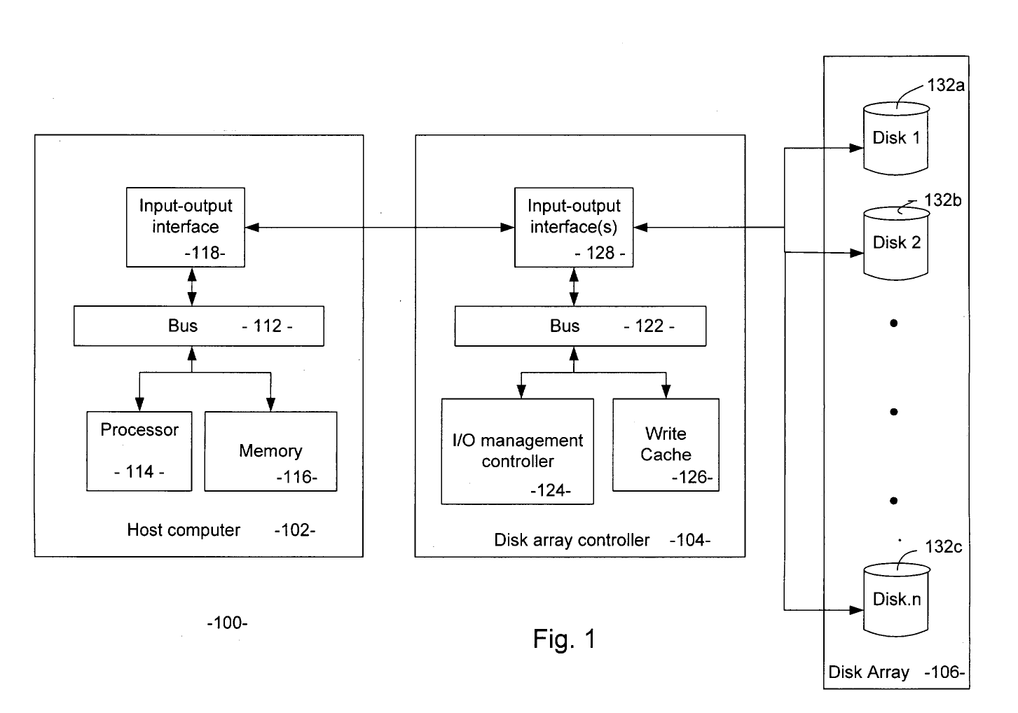

FIG. 1 depicts a high-level block diagram of a data storage system 100 including an embodiment of the present invention. The data storage system 100 comprises a disk array controller 104 arranged between a host computer 102 and a disk storage array 106. The host computer 102 may include a processor 114, a memory 116, and an input/output interface 118 sharing a bus 112. The memory 116 may include a program storage section for storing program instructions for execution by the processor 114. The input/output interface 118 may use a standard communications protocol, such as the Small Computer System Interface (or “SCSI”) protocol for example, to facilitate communication with peripheral devices. The disk array 106 may include an array of magnetic or optical disks 132 for example.

The disk array controller 104 includes an I/O management controller 124, a write cache 126, and input/output interface(s) 128, which share a bus 122. The I/O management controller 124, which may be an application specific integrated circuit (or “ASIC”) or a processor executing stored instructions for example, controls reading from and writing to the write cache 126 and the disk array 106. The input/output interface(s) 128 may use the SCSI protocol to facilitate communication between the interface 128, the host computer 102, and the disk array 106.

Briefly stated, if the processor 114 of the host computer 102 issues a write request for a new set of data to the disk array controller 106, the write cache is traversed to locate sets of data blocks overlapping the new set of data in the write command. Similarly, if the processor 114 of the host computer 102 issues read request to the disk array controller 106, the write cache is traversed to locate sets of data blocks (i.e., data blocks of a write request previously stored as dirty data in the write cache that overlap the new read request, each data block may comprise one or more write cache “lines”) overlapping the data in the read command. For a write request, in one embodiment, if a located entry identifies a set of data blocks in a single cache line fully overlapping the new set of data in the write request there is a full hit. In another embodiment, if the new write request data is fully identified with data blocks in more than one write cache, the request is a full hit. If the request is a read request, if a located entry identifies a set of data blocks fully overlapping the new set of data the read request even if the data is in more than one write cache line, there is a full hit. In the case where the data block comprise more than one write cache line, the hit is considered “dirty” to the extent that any of the write cache lines is marked dirty. If no entry is located, there is a miss. Otherwise, there is a partial hit.

The present invention advantageously provides a method for flushing write cache data that minimizes the risk of loss of dirty data, while maintaining a high level of data blocks in the write cache to maximize the “hit” ratio of a system. In one embodiment of the present invention, the method is performed using a “forced flush” in combination with a “threshold flush” and a “background flush” operating in the background.

In the forced flush method of the present invention, a storage request from a host (either a read request or a write request) is compared to the data in the write cache to determine if there is a hit. The operation of the forced flush method varies depending on if the storage request is a read request or a write request, if the data in the write cache associated with the storage request is either dirty data or resident data, and if there has been a full hit, a partial hit, or a miss. As mentioned previously, dirty data is data, in the form of lines marked dirty, in the write cache not yet written to persistent memory. Resident data is data in the write cache that has already been written in the persistent memory.

In the case of a read request, there are three possible alternatives: the data is fully within the cache, partially there or not there at all. As well, the data may be dirty or not dirty. If requested data and the data in the write cache comprises a full hit, i.e., the write cache includes all of the data requested by the read request, regardless of whether the data is dirty or not, and regardless of whether the data is in more than one line, the disk array controller responds to the host's read request with data from the write cache. There is no need to access the storage disks.

If the requested data and the data in the write cache comprises a partial hit, i.e., the data includes some but not all of the requested data, then the disk array controller responds differently depending on whether the data is dirty or not. When the data is dirty, the dirty cache line(s) in the write cache containing the partial hit is first flushed to the appropriate storage disk along with the read request. Then, regardless of whether the data was dirty, the disk array controller accesses the appropriate storage disk to respond to the host's read request. The disk array controller then transfers the data to both to the write cache and to the host.

If the read request and the data in the write cache do not overlap at all (miss), the disk array controller accesses the appropriate storage disk to respond to the read request from the host. The disk array controller transfers the read data to the write cache and eventually to the host.

In the case of a write request, there are three possible alternatives: a full hit, a partial hit or a miss. As well, the data may be dirty or not dirty. If the new data of the write request and the data in the write cache comprise a full hit, i.e., entirely overlaps in a single cache line in one embodiment, or in more than one write cache line in another embodiment, the disk array controller responds differently depending on whether the data is dirty or not. If the data is dirty, the dirty data block (cache line(s)) in the write cache is overwritten with the new data, and the written new data is marked as dirty data. There is no need to access the storage disks. If the data includes a write cache line that is not dirty, non dirty, resident the write cache line containing the new write data is invalidated and the new write data is stored in a new write cache line and marked dirty.

If the new data of the write request and the data in the write cache comprise a partial hit, i.e., not fully contained in a single write cache line even though it might be present in a number of write cache lines in one embodiment, or if it is not fully contained in more than one write cache line in another embodiment, the disk array controller responds differently depending on whether the write cache line(s) is dirty or not. If the write cache line(s) is dirty, the disk array controller flushes the dirty data cache line containing the partial hit to an appropriate storage disk, stores the new write data into the write cache and marks it as dirty data. If the any of the write cache lines are not dirty, the disk array controller invalidates the the resident, non dirty write cache lines containing the new write data block, stores the new write data into the write cache in the form of a single write cache line and marks it as dirty data.

If the new data of the write request and the data in the write cache do not overlap at all (miss), then disk array controller writes the new data to the write cache in the form of a single write cache line and marks it as dirty data.

As data is written into the write cache, as for example resulting from a storage request, the disk array controller maintains a counter in the write cache to evaluate the amount of data in the write cache. If the amount of data in the write cache exceeds a predetermined threshold level, preferably set by a user, the disk array controller begins to flush the dirty data at a maximum rate. This threshold level represents a balance between the risk of containing a large amount of data that can be lost in the event of a failure and the desire to keep a fair amount of data in the write cache to maintain a high hit ratio and minimize the processing time of executing storage requests from a host.

For example, if the user sets the threshold level to seventy-five percent, the threshold is exceeded when the disk array controller writes a data block to the write cache that causes the counter to exceed seventy-five percent. Seventy-five percent is chosen solely for the purposes of illustration. It will be appreciated by those skilled in the art that various values for the threshold level can be implemented within the concepts of the present invention. The user will preferably adjust the threshold level depending on system parameters and the desired system performance

When the threshold maximum flush method is activated, the dirty data in the write cache is flushed to the storage disks at a maximum transfer rate. The rate is chosen to minimize the processing time required for the flushing. Once the level of data stored in the write cache falls below the aforementioned predetermined threshold level, the threshold maximum flush method is exited.

The disk array controller also checks the threshold counter when it periodically activates a background flush. The background flush method of the present invention functions when the amount of data in the write cache is below the threshold level. In one embodiment of the present invention, the user may set the timing of the background flush intervals. When the background flush is activated, the disk array controller flushes dirty data in the write cache at a rate slower than the rate it flushes data during the threshold maximum flush method. The background flush attempts to slowly reduce the amount of dirty data blocks contained in the write cache while maintaining a high probability of cache hits. As the level of data in the write cache drops, the flush rate also drops in order to maintain a high probability of cache hits in response to storage requests from a host. The background flush is exited when the period set for the activation of the background flushing terminates. It will be appreciated by those skilled in the art that various values for the frequency of activation, period of activation, and flushing rates for the background flush method can be implemented within the present invention. These values are dependent on the functionality desired by a user. In another embodiment of the present invention, the background flushing can be activated manually by a user by sending a command to the disk array controller.

It should be noted that both the threshold flushing method and the background flushing method implement a sequential method of flushing. That is, dirty data is stored in a sequential list in the write cache by logical block address (LBA). After the completion of a flush, the list indicates at what point the last flush was performed and in a subsequent flush routine, the flushing would continue from the point where the flush last left off. For example, if two data blocks with an LBA of two and four are stored in the write cache and represented in the sequential list in the cache, and if the last flushing technique stopped flushing after LBA two, a subsequent data block with an LBA of three, stored in the write cache memory and represented in the sequential list in the cache, would be flushed next in a subsequent flushing routine.

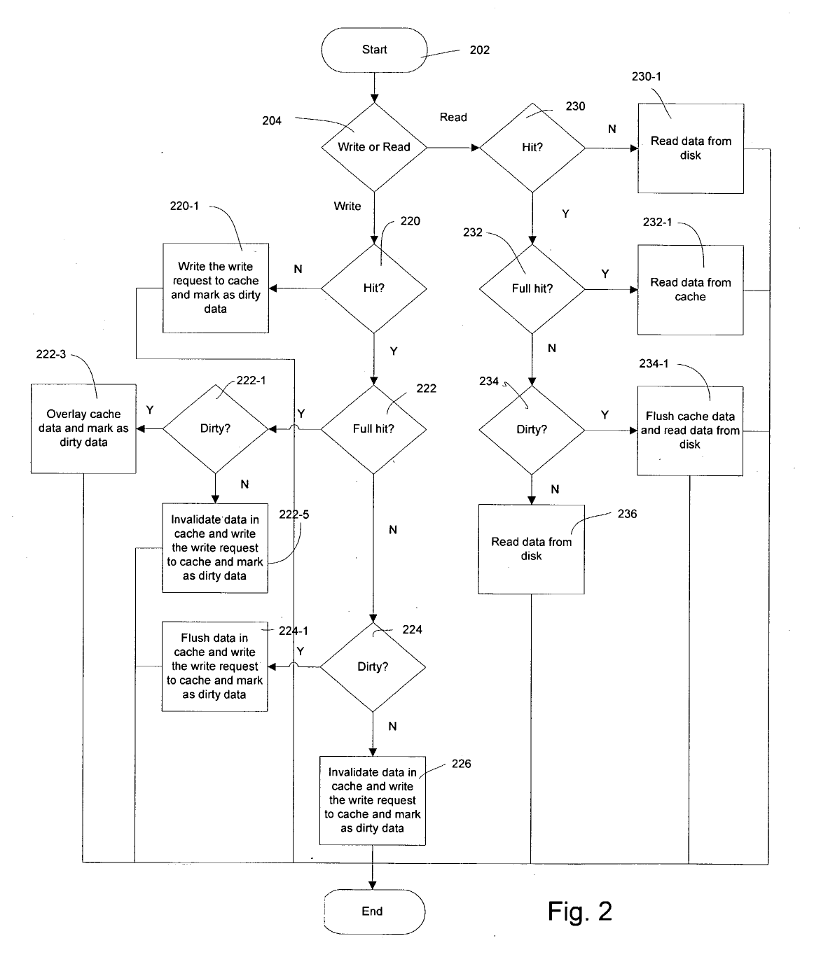

FIG. 2 depicts a flow diagram of an embodiment of a method of the present invention for forced flushing. The method 200 is entered at step 202 when a storage request from a host is sent to the disk array controller. At step 204, the method 200 determines if the storage request is a write request or a read request. If the storage request is a write request, the method 200 proceeds to step 220. If the storage request is a read request, the method 200 jumps to step 230.

At step 220, the method determines if a hit has occurred between the write request and the write cache data. If no hit has occurred, the method proceeds to step 220-1. If a hit has occurred, the method 200 proceeds to step 222.

At step 220-1, the write data is written to the write cache and marked as dirty data. The method 200 then ends.

At step 222, the method determines if the hit is a full hit. If the hit is a full hit, the method 200 proceeds to step 222-1. If the hit is a partial hit, the method 200 proceeds to step 224.

At step 222-1 the method 200 determines whether the full hit in the write cache comprises dirty data. If the full hit comprises dirty data, the method 200 proceeds to step 222-3. If the full hit does not comprise dirty data (comprises resident data), the method 200 proceeds to step 222-5.

At step 222-3, the dirty data in the write cache is overlaid and the write request is written to the write cache and marked as dirty data. The method 200 then ends.

At step 222-5, the data block (cache line(s)) comprising the full, but non dirty, hit in the write cache is invalidated and the write request is written to the write cache and marked as dirty The method 200 then ends.

As previously mentioned, if the hit is a partial hit the method 200 proceeds to step 224. At step 224, the method 200 determines if the partial hit in the write cache comprises dirty data. If the partial hit comprises dirty data, the method 200 proceeds to step 224-1. If the partial hit does not comprise dirty data, the method 200 proceeds to step 226.

At step 224-1, the data in the write cache comprising the partial hit is flushed to the designated storage disk, and the write request is written to the write cache and marked as dirty. The method 200 then ends.

At step 226, the data block (cache line(s)) comprising the partial hit in the write cache is invalidated and the write request is written to the write cache and marked as dirty. The method 200 then ends.

As previously mentioned, if the storage request is a read request, the method 200 jumps to step 230. At step 230, the method determines if a hit has occurred between the read request and the write cache data. If no hit has occurred, the method proceeds to step 230-1. If a hit has occurred, the method 200 proceeds to step 232.

At step 230-1, the read data is read from the designated storage disk. The method 200 then ends.

At step 232, the method determines if the hit is an full hit. If the hit is a full hit, the method 200 proceeds to step 232-1. If the hit is a partial hit, the method 200 proceeds to step 234.

At step 232-1, the read data is read from the cache. The method 200 then ends. Whether the full hit comprises dirty data or resident data is irrelevant. In both cases, the read data is read from the cache. The method 200 then ends.

At step 234, the method 200 determines if the partial hit in the write cache comprises dirty data. If the partial hit comprises dirty data, the method 200 proceeds to step 234-1. If the partial hit does not comprise dirty data, the method 200 proceeds to step 236.

At step 234-1, the dirty data in the write cache comprising the partial hit is flushed to the designated storage disk, and the read request is read from the designated storage disk. The method 200 then ends.

At step 236, the read data is read from the designated storage disk. The method 200 then ends.

As mentioned in the disclosure above, a counter in the write cache monitors the level of the data stored in the cache. If the level in the write cache exceeds a predetermined threshold level, the threshold maximum flush method is activated.

While the foregoing is directed to the preferred embodiment of the present invention, other and further embodiments of the invention may be devised without departing from the basic scope thereof, and the scope thereof is determined by the claims that follow.

What is claimed is:

1. A method for flushing write cache data, comprising:
a) receiving a storage request;
b) determining whether said storage request comprises a partial hit with dirty data stored in a cache; and
c) flushing, if the storage request is determined to be a partial hit, the dirty data of the write cache comprising the partial hit.

2. The method of claim 1, further comprising:
d) determining whether the amount of data stored in the write cache exceeds a predetermined threshold; and
e) flushing, if the data stored in the write cache exceeds the predetermined threshold, dirty data stored in the write cache until the amount of data stored in the write cache no longer exceeds said predetermined threshold.

3. The method of claim 2, wherein the flushing is performed at a maximum transfer rate.

4. The method of claim 2, wherein the predetermined threshold is a predetermined percentage of the maximum capacity of the cache.

5. The method of claim 2, wherein the dirty data is flushed sequentially according to a logical block array list in the cache.

6. The method of claim 1, further comprising:
a) determining whether the amount of data stored in the write cache exceeds a predetermined threshold; and
b) flushing, if the data stored in the write cache does not exceed the predetermined threshold, dirty data stored in the cache.

7. The method of claim 6, wherein the flushing is performed at a transfer rate that is slower than a maximum transfer rate.

8. The method of claim 6, wherein the dirty data is flushed sequentially according to a logical block array list in the cache.

9. In a system having a host computer and a mass storage device, a disk array controller comprising:
a) an input/output interface for permitting communication between the host computer, the mass storage controller, and the mass storage device;
b) a write cache having a number of cache lines, some of which cache lines may include dirty data; and
c) an input/output management controller, the input output management controller including
i) means for receiving a storage request;
ii) means for determining whether said storage request comprises a partial hit with dirty data stored in a cache; and
iii) means for flushing, if the storage request is determined to be a partial hit, the dirty data of the write cache comprising the partial hit.

10. The device of claim 9, further comprising:
iv) means for determining whether the amount of data stored in the write cache exceeds a predetermined threshold; and
v) means for flushing, if the data stored in the write cache exceeds the predetermined threshold, dirty data stored in the write cache until the amount of data stored in the write cache no longer exceeds said predetermined threshold.

11. The device of claim 9, further comprising:
iv) means for determining whether the amount of data stored in the write cache exceeds a predetermined threshold; and
v) means for flushing, if the data stored in the write cache does not exceed the predetermined threshold, dirty data stored in the cache.

12. A method for caching data, comprising:
a) determining whether a host storage request is a write or a read request;
b) determining whether data of the host storage request is fully, partially or not present in a one or more write cache lines of a write cache, some of which may be dirty, the determination representing a full hit, partial hit or a miss;
in response to a write request,
c) if the one or more write cache lines comprising a full hit are all marked dirty, overlaying the full-hit write cache lines dirty data with host storage request data;
d) if a hit is full and one or more of the write cache lines comprising the full hit are not marked dirty, invalidating all such full hit non dirty write cache lines, writing the host storage request data to the write cache to create a new write cache line and marking that new write cache line as dirty; and
e) if the host storage request data is partially present and overlapping the write cache data in one or more write cache lines and one or more of these overlapping write cache lines are marked dirty, flushing the one or more of these partial-hit dirty write cache lines to persistent data storage, invalidating any overlapping write cache lines that are not dirty, storing the host storage request data in the write cache as a new write cache line and marking that new write cache line as dirty; and in response to a read request,
f) if any write cache line of a partial hit is marked dirty, flushing the partial-hit dirty write cache line(s) to a persistent data storage device and then reading the requested data from the persistent data storage device.

13. The method according to claim 12 further comprising, in response to a read request:
g) if a full hit, responding to the host storage request with the one or more write cache lines containing requested data without flushing the dirty write cache lines to persistent data storage.
